(19) United States
(12) Patent Application Publication
(10) Pub. No.: US 2014/0354821 A1
(43) Pub. Date: Dec. 4, 2014

(54) Covert Networked Security Camera

(71) Applicant: David A. Monroe, San Antonio, TX (US)

(72) Inventor: David A. Monroe, San Antonio, TX (US)

(21) Appl. No.: 13/903,037

(22) Filed: May 28, 2013

(51) Int. Cl. H04N 7/18

(52) U.S. Cl. CPC H04N 7/18
USPC 348/159; 348/143

(57) ABSTRACT

A digital networked security surveillance system for use in a covert environment comprises a camera enclosure including a video camera and a pan-tilt camera mount mechanism, a mounting plate coupled to the enclosure, wherein a lens of the camera is adjacent to at least one of transparent viewing panes, wherein the viewing pane may be disguised with a semi-transparent decal to prevent individuals from seeing the camera, yet can allow the camera to capture light originating outside of the enclosure, and an encoder coupled to the mounting plate, wherein the encoder is adapted to digitize and compress video.

### CROSS-REFERENCE TO RELATED APPLICATIONS

The present invention is related to and claims the benefit of provisional patent application No. 60/624,598, filed on Nov. 3, 2004, titled, Covert Networked Security Camera, the entire contents of which are enclosed by reference herein.

The present invention is also related to patent application Ser. No. 09/593,901, filed on Jun. 14, 2000, titled DUAL MODE CAMERA, patent application Ser. No. 09/593,361, filed on Jun. 14, 2000, titled DIGITAL SECURITY MULTIMEDIA SENSOR, patent application Ser. No. 09/594,041, filed on Jun. 14, 2000, titled MULTIMEDIA SURVEILLANCE AND MONITORING SYSTEM INCLUDING NETWORK CONFIGURATION, patent application Ser. No. 09/716,141, filed on Nov. 17, 2000, titled METHOD AND APPARATUS FOR DISTRIBUTING DIGITIZED STREAMING VIDEO OVER A NETWORK, patent application Ser. No. 09/715,783, filed on Nov. 17, 2000, titled MULTIPLE VIDEO DISPLAY CONFIGURATIONS AND BANDWIDTH CONSERVATION SCHEME FOR TRANSMITTING VIDEO OVER A NETWORK, from pending patent application Ser. No. 09/725,368, filed on Nov. 29, 2000, titled MULTIPLE VIDEO DISPLAY CONFIGURATIONS AND BANDWIDTH CONSERVATION SCHEME FOR TRANSMITTING VIDEO OVER A NETWORK, patent application Ser. No. 09/854,033, filed on May 11, 2001, titled PORTABLE, WIRELESS MONITORING AND CONTROL STATION FOR USE IN CONNECTION WITH A MULTI-MEDIA SURVEILLANCE SYSTEM HAVING ENHANCED NOTIFICATION FUNCTIONS, patent application Ser. No. 09/853,274 filed on May 11, 2001, titled METHOD AND APPARATUS FOR COLLECTING, SENDING, ARCHIVING AND RETRIEVING MOTION VIDEO AND STILL IMAGES AND NOTIFICATION OF DETECTED EVENTS, patent application Ser. No. 09/960,126 filed on Sep. 21, 2001, titled METHOD AND APPARATUS FOR INTERCONNECTIVITY BETWEEN LEGACY SECURITY SYSTEMS AND NETWORKED MULTIMEDIA SECURITY SURVEILLANCE SYSTEM, patent application Ser. No. 09/966,130 filed on Sep. 21, 2001, titled MULTIMEDIA NETWORK APPLIANCES FOR SECURITY AND SURVEILLANCE APPLICATIONS, patent application Ser. No. 09/974,337 filed on Oct. 10, 2001, titled NETWORKED PERSONAL SECURITY SYSTEM, patent application Ser. No. 10/134,413 filed on Apr. 29, 2002, titled METHOD FOR ACCESSING AND CONTROLLING A REMOTE CAMERA IN A NETWORKED SYSTEM WITH A MULTIPLE USER SUPPORT CAPABILITY AND INTEGRATION TO OTHER SENSOR SYSTEMS, patent application Ser. No. 10/163,679 filed on Jun. 5, 2002, titled EMERGENCY TELEPHONE WITH INTEGRATED SURVEILLANCE SYSTEM CONNECTIVITY, patent application Ser. No. 10/266,813 filed on Oct. 8, 2002, titled ENHANCED APPARATUS AND METHOD FOR COLLECTING, DISTRIBUTING, AND ARCHIVING HIGH RESOLUTION IMAGES, patent application Ser. No. 10/719,792 filed on Nov. 21, 2003, titled METHOD FOR INCORPORATING FACIAL RECOGNITION TECHNOLOGY IN A MULTIMEDIA SURVEILLANCE SYSTEM RECOGNITION APPLICATION, patent application Ser. No. 10/753,658 filed on Jan. 8, 2004, titled MULTIMEDIA COLLECTION DEVICE FOR A HOST WITH SINGLE AVAILABLE INPUT PORT, patent application No. 60/624,598 filed on Nov. 3, 2004, titled COVERT NETWORKED SECURITY CAMERA, patent application Ser. No. 09/143,232 filed on Aug. 28, 1998, titled MULTIFUNCTIONAL REMOTE CONTROL SYSTEM FOR AUDIO AND VIDEO RECORDING, CAPTURE, TRANSMISSION, AND PLAYBACK OF FULL MOTION AND STILL IMAGES, patent application Ser. No. 09/687,713 filed on Oct. 13, 2000, titled APPARATUS AND METHOD OF COLLECTING AND DISTRIBUTING EVENT DATA TO STRATEGIC SECURITY PERSONNEL AND RESPONSE VEHICLES, patent application Ser. No. 10/295,494 filed on Nov. 15, 2002, tided APPARATUS AND METHOD OF COLLECTING AND DISTRIBUTING EVENT DATA TO STRATEGIC SECURITY PERSONNEL AND RESPONSE VEHICLES, patent application Ser. No. 10/192,870 filed on Jul. 10, 2002, titled COMPREHENSIVE MULTI-MEDIA SURVEILLANCE AND RESPONSE SYSTEM FOR AIRCRAFT, OPERATIONS CENTERS, AIRPORTS AND OTHER COMMERCIAL TRANSPORTS, CENTERS, AND TERMINALS, patent application Ser. No. 10/719,796 filed on Nov. 21, 2003, titled RECORD AND PLAYBACK SYSTEM FOR AIRCRAFT, patent application Ser. No. 10/336,470 filed on Jan. 3, 2003, titled APPARATUS FOR CAPTURING, CONVERTING AND TRANSMITTING A VISUAL IMAGE SIGNAL VIA A DIGITAL TRANSMISSION SYSTEM, patent application Ser. No. 10/326,503 filed on Dec. 20, 2002, titled METHOD AND APPARATUS FOR IMAGE CAPTURE, COMPRESSION AND TRANSMISSION OF A VISUAL IMAGE OVER TELEPHONIC OR RADIO TRANSMISSION SYSTEM, patent application Ser. No. 10/776,129 filed on Feb. 11, 2004, titled SYSTEM FOR A PLURALITY OF VIDEO CAMERAS DISPOSED ON A COMMON NETWORK and from pending patent application Ser. No. 10/971,857, filed on Oct. 22, 2004, titled MULTIPLE VIDEO DISPLAY CONFIGURATIONS AND REMOTE CONTROL OF MULTIPLE VIDEO SIGNALS TRANSMITTED TO A MONITORING STATION OVER A NETWORK, patent application Ser. No. 11/057,645 filed on Feb. 14, 2005, titled MULTIFUNCTIONAL REMOTE CONTROL SYSTEM FOR AUDIO AND VIDEO RECORDING, CAPTURE, TRANSMISSION AND PLAYBACK OF FULL MOTION AND STILL IMAGES, patent application Ser. No. 11/057,814, filed on Feb. 14, 2005, titled DIGITAL SECURITY MULTIMEDIA SENSOR, and patent application Ser. No. 11/057,264, filed on Feb. 14, 2005, titled NETWORKED PERSONAL SECURITY SYSTEM, patent application number 11,111,575, filed on Apr. 21, 2005, titled BANDWIDTH MANAGEMENT AND CONTROL, the contents of each of which are enclosed by reference herein.

### BACKGROUND OF THE INVENTION

1. Field of the Invention

The subject invention is directed to a related to networked security systems and is specifically directed to a digital networked security surveillance system in a covert environment.

2. Description of the Prior Art

Smart cameras, that is, cameras with sensor triggers wherein the camera is activated only upon the occurrence of a pre-defined event, are well known. For example, PhotoTelesis Corporation of San Antonio, Tex. manufactures a product line of IP Video Surveillance Systems under the name e-Watch, including smart cameras that have built in intelligence and IP interfaces. In addition, E-Watch provides network servers and server software which record security information on the server, and applications software that present video, image and other data to any of a plurality of monitoring station or stations on a wide area network (WAN), local area network (LAN) or the Internet. The system utilizes wired and wireless IP communications throughout.

It is often desirable that such security surveillance systems be adapted to be located in public places without detection. While it is known to place such systems behind one-way mirrors, walls with pin-hole cameras and other “hidden” locations, such installations are not useful when the system has to be installed in an open area such as a field, a perimeter fence or on an open border or the like. In installations of this type, the system is in plain view but must not be detectable as a surveillance system. In addition, it must be serviceable by technicians and installers that do not know the nature of the system.

### SUMMARY OF THE INVENTION

The subject invention is directed to a covert surveillance system that can be installed and serviced by technicians without disclosing the nature of the system. In addition, once installed the nature of the system is undetectable even though it may be in plain view. The system utilizes wired and wireless IP communications throughout. This system can be extended with various features.

These features describe a modular surveillance system that include:
A housing system that provides environmental protection for the system.
Modular design that provides for field configuration of system.
A mounting system within the rack to provide for a modular system.
Population of the housing system and rack to provide for multiple configurations.
Modular functions follow:
   Incoming power termination.
   Power conditioning for lightening and surge protection.
   Remote temperature/humidity monitoring.
   Remote power control for remote resetting of system.
   AC to DC conversion for running modules.
   Optional climate control for maintaining temperature of electronics and prevention of condensation on optics.
   One or more camera/sensors
   One or more optional tilt/pan unit for the camera
   IP camera or cameras, or analog camera or cameras with IP encoder(s)
   “Smart Camera” functions, image processing, alarm detection.
   An Ethernet Switch
   An IP Router
   Encryption
   A WAN interface
   Lightening and surge protection for the WAN interface
   One or more Wireless Access Point
   Lightening protection for Access Point (s)
   One or more Wireless Bridge
   Lightening protection for Wireless Bridge (s)
   One or more antennas for Wireless Access point (s)
   One or more antennas for Wireless Bridge(s)
   A Geolocation device, such as GPS and Antenna
   A mini-server for data collection and/or control

Note that one or more of the above functions may be combined in one physical module, such as Power Conditioning, Remote Power Control, and AC to DC Conversion. Also note that the system may be configured for the specific installation as required. For example, the system may be configured for the combined functions of camera surveillance, WAN interface, wireless bridging and wireless Access Point providing. Another configuration example would be for wireless surveillance only. Yet another configuration example would be as a WAN to wireless relay station only.

It is important to note that because the system is modular, it can be field configured, serviced, and upgraded. Functionality can be increased in the field, an example being upgrading a wireless relay station being upgraded to provide a camera sensor for surveillance in addition to the relay function.

### BRIEF DESCRIPTION OF THE DRAWINGS

FIG. 1 depicts a networked surveillance system in accordance to a preferred embodiment of the present invention;

FIG. 2 depicts an overall view of the covert camera system in accordance to a preferred embodiment of the present invention;

FIG. 3A depicts the overall camera/pan-tilt enclosure in accordance to a preferred embodiment of the present invention;

FIG. 3B depicts a module with the exterior surface intact in accordance to a preferred embodiment of the present invention;

FIG. 4A depicts a set of Metal Oxide Varistor (MOV) devices in accordance to a preferred embodiment of the present invention;

FIG. 4B depicts thermal fuses located in series with an MOV array in accordance to a preferred embodiment of the present invention;

FIG. 5A depicts a wireless usage of the system in accordance to a preferred embodiment of the present invention;

FIG. 5B depicts a connection between a wide-area-network and a covert networked camera in accordance to a preferred embodiment of the present invention;

FIG. 6A depicts a camera supporting a local ‘hot spot’ in accordance to a preferred embodiment of the present invention;

FIG. 6B depicts how two or more covert network cameras may be interconnected in accordance to a preferred embodiment of the present invention; and

FIG. 7 depicts cascaded network cameras supplemented with wireless access points and associated antennas in accordance to a preferred embodiment of the present invention.

FIG. 8 depicts an alternative system configuration.

### DETAILED DESCRIPTION OF THE INVENTION

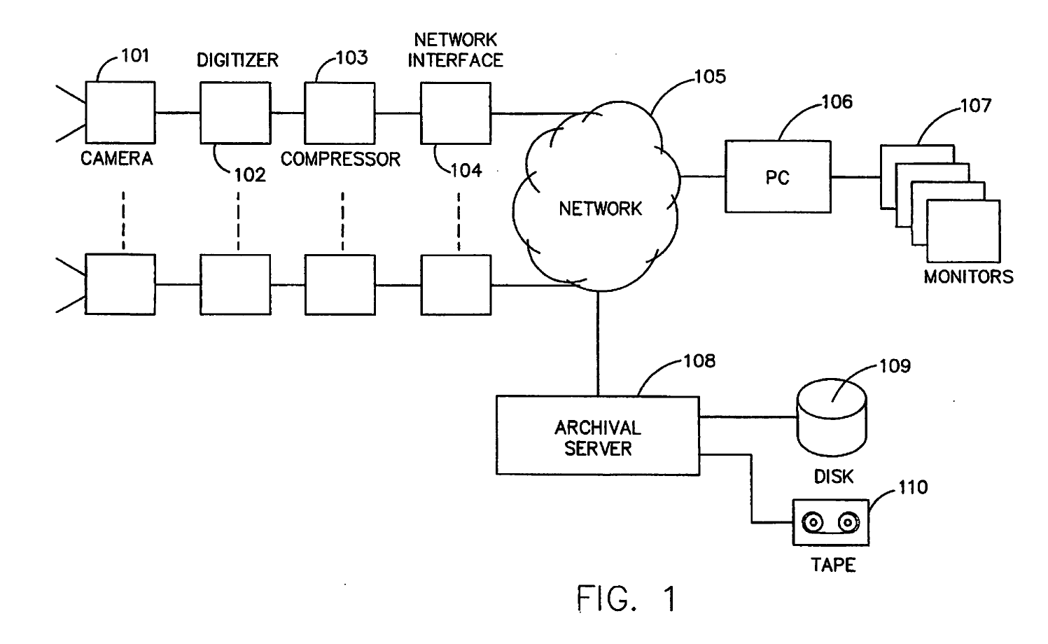

FIG. 1 summarizes a networked surveillance system of the present invention, as previously disclosed in a number of the aforementioned cross-referenced patent applications including the following: Multimedia Surveillance and Monitoring System Including Network Configuration, Ser. No. 09/594,041, filed on Jun. 14, 2000; Method and Apparatus for Distributing Digitized Streaming Video Over a Network, Ser. No. 09/716,141, filed on Nov. 17, 2000; and Method and Apparatus for Collecting, Sending, Archiving and Retrieving Motion Video and Still Images and Notification of Detected Events, Ser. No. 09/853,274, filed May 11, 2001, each of which is incorporated by reference herein.

In FIG. 1, a network 5 supports one or more surveillance cameras. Each camera is an IP camera that streams still frames or motion video over an IP network. It contains a means for compressing a video signal captured by camera 101, and a means for conveying said compressed visual data via a network interface. Video thus networked may be viewed at one or more monitoring stations 106/107, and may be stored via an archival server 8. One or more cameras may also be “intelligent”, containing a processor for motion detection, motion analysis, facial recognition, or other advanced processing, and one or more cameras may also provide more than one stream of images and/or video, such as is described in at least one of the above cross-referenced patent applications. The archival server, as described in the co-pending applications, also serves as a central control and/or data storage point for various surveillance network functions. One or more servers may be provided for redundancy, for large storage capacity, or for task splitting among servers. For example, alarm conditions generated by the various cameras or other sensors are processed, forwarded, logged, or suppressed by the server. In addition Images and/or video captured by the surveillance camera can be stored on the server, Control screens, such as HTML message screens, can be served by one or more of these servers. Image and Video rebroadcasters may also be implemented.

In addition, or in lieu of, data storage may be supplied locally in the housing. This allows capture and recording of surveillance data during network outages, peak network usage times which may reduce bandwidth for periods of time, or when circuits only of low bandwidth are available. This is described in at least one of the aforementioned cross-referenced patent applications.

The Remote Surveillance System can be configured to generate a variety of system alarms such as:
Region of Interest
Motion Detection
Facial Recognition
Visual Signature Analysis
Object pickup-dropoff detection
And the like

A number of prior-art covert surveillance cameras are currently available for sale, from such manufacturers as NS Microwave and DCT Communications Inc. These systems are analog systems, using uncompressed analog video carried via a microwave radio channel to a central viewing/recording site. Some of these prior-art systems have additional features such as pan/tilt camera mounts, remote system on/off, and the like. However, as analog systems they inevitably exhibit certain deficiencies, such as:
They are limited to Line-of-Sight only
Video is not easily available on Wide Area Networks.
Analog video channels are difficult to secure effectively
They use analog tape recording—unreliable.
Limited Features

In the present invention, the networked security camera is preferably enclosed in a nondescript ‘utility’ enclosure, of the sort often seen (and taken for granted) on utility poles, or on buildings near power entry panels, and so on. No external indication of the enclosure's purpose is visible, and the enclosure is almost certainly overlooked or ignored by passers-by. In this ‘covert’ form, the camera may be unobtrusively installed in selected areas of interest without attracting notice.

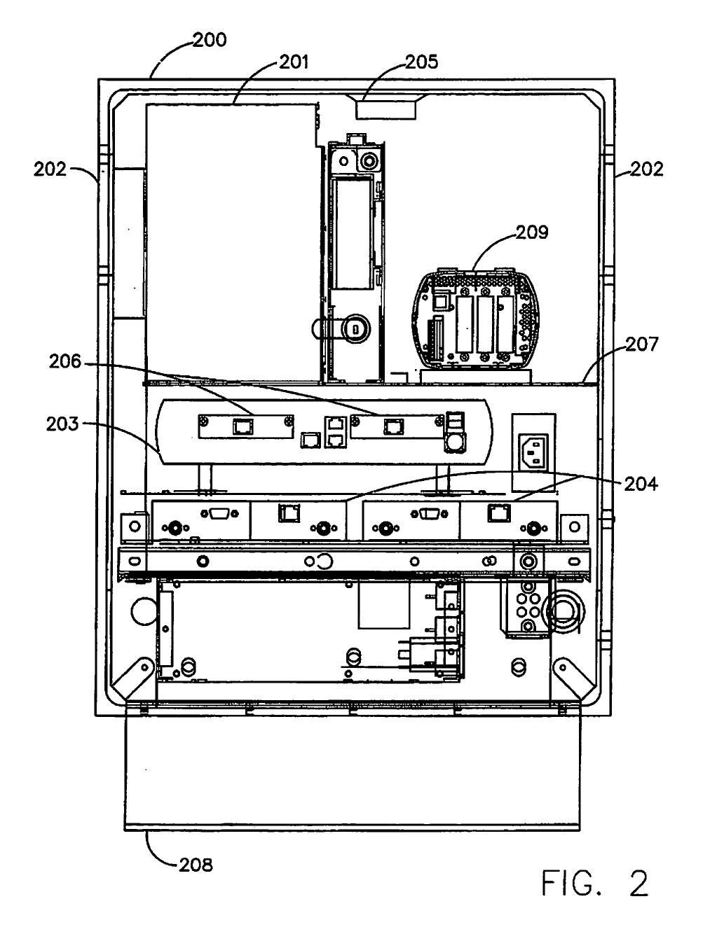

In this setting, certain new features are added to the camera, to increase its utility and to preserve its covert nature. Prior-art covert cameras used analog video distribution methods, such as hard-wired cables, or sometimes RF video links, to a monitoring station. The present invention takes advantage of modern data networking techniques to distribute the video. FIG. 2 depicts an overall view of the covert camera system. Enclosure 200 is a simple, unadorned outdoor utility enclosure. It is typically of a dull gray color, and may be constructed of metal, plastic or composites. In the preferred embodiment, for outdoor use the enclosure is designed to be weatherproof and watertight, confirming to well-established environmental standards such as NEMA 250-2003.

The internal camera may be fixed in position, or may be movable. As illustrated, internal camera enclosure 201 contains a video camera and a pan-tilt camera mount mechanism. It is installed on a mounting plate 207 inside the enclosure, such that the camera lens is adjacent to one of the transparent viewing panes 202. Viewing pane 202 may be disguised with a semi-transparent decal to prevent installers or passers-by to see the internal camera, yet can allow the camera to capture light originating outside of the box. In the preferred embodiment, in addition to the camera/pan-tilt enclosure 201, mounting plate 207 contains an encoder 209, which digitizes and compresses the camera video, as described in the foregoing.

In addition, enclosure 200 contains a variety of equipment required for communications and networking, including Network Router 203, one or more Wireless Bridges or Wireless Access Points 204, wired-LAN interface 206, and so on. This allows the system's camera enclosure 201 to be installed on either side of the overall enclosure 200, depending on actual surveillance requirements. Additional viewing panes may be located on the front and rear surface of the enclosure, to allow the cameral pan-tilt enclosure to be positioned to view through these surfaces.

It is contemplated that several methods of viewing may be implemented:
1) One camera may be positioned, with or without a pan/tilt in one window.
2) More than one camera may be positioned, with or without a pan/tilt, in more than one window.
3) One camera on a wide-angle pan/tilt may be positioned such that it can view out of two or more windows.
4) An omni-directional sensor, such as is described in at least one of the cross-referenced patent applications or an omnidirectional lens assembly such as the one manufactured by Remote Reality Inc. can be mounted such that it views out of two or more windows.

In the present invention, enclosure 200 additionally contains a small geolocation device. In the preferred embodiment this is a GPS receiver 205. The receiver may be of the two-part variety, with a separate receiver module and antenna module, or may be an integrated variety with the receiver and antenna packaged in one enclosure and a power/data connection running out of the package.

This antenna or antenna/receiver combo is mounted near the top inner surface of the enclosure, to provide the receiver with an unobstructed view of the sky. Obviously, enclosure 200 must either be non-metallic, or must contain a non-metallic top window to allow the receiver to function. Optionally the GPS antenna or antenna receiver may be mounted on top of or otherwise outside of the enclosure. This receiver produces accurate information describing the current position of the system. This data may be “stamped” on the images and video data that is being transmitted or recorded locally. It may also provide additional important information such as an accurate time stamp which can also be stored with the images and/or video locally, or transmitted. This is useful, since the system may be frequently re-located. Availability of accurate position information allows the associated network server to update maps that depict the location of the system.

In Other geo-location means may also be used in lieu of GPS. An example of another means is cellular telephone whereby the unit would be equipped with a cellular or two-way pager type of transceiver of which the system is outfitted for geo-location by any of the well-known means. Such means are currently utilized in cellular “911” schemes for identifying the location of a 911 caller in emergency situations. These systems may also utilize GPS, or may utilize other triangulation, phase analysis, or time domain techniques that are well known to the industry.

Often, such networking equipment is intended for indoor usage. Enclosure 200 may provide adequate environmental protection against precipitation and ice, but does nothing to guarantee that the networking equipment is kept within its operating temperature range. Accordingly, a heating/cooling device 208 is installed in the enclosure, to guarantee that the networking equipment stays within its specified temperature range. This cooling device may be a conventional air conditioning module, or may be a solid-state thermoelectric cooler (TEC).

To enhance the physical security of the device, a door switch is added to alert monitoring personnel when the system's door has been opened. This switch may take a variety of forms, but the preferred embodiment is that of a simple plunger switch mounted on the front surface of the system mounting frame. This is similar to the switch commonly used in household appliances, which for example turn on a light when a refrigerator door is opened. This switch is preferably mounted nearest the door's hinge, to reduce the possibility that an intruder might crack the door slightly and keep the plunger depressed using a tool. In operation, the door switch is connected to a pair of terminals on the video encoder assembly. When the door is opened, the video encoder assembly generates and sends a message to network server(s). Servers record this event, and forward alarm messages to a networked monitoring station or stations. Monitoring stations may then alert operators to the event, for example by highlighting and/or flashing an icon on the monitor screen. The icon may be accompanied by an audible alert if desired, and may additionally indicate the identity and location of the camera where the intrusion has occurred.

Covert, Reversible Camera Box

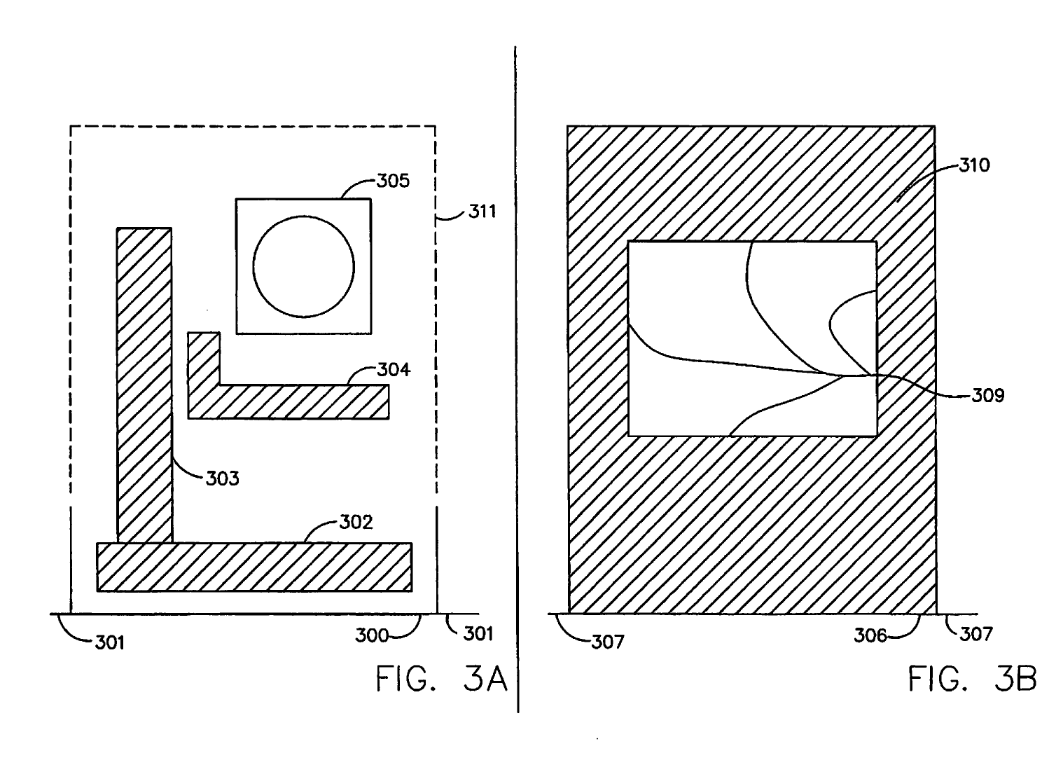

As a covert device, it is desirable to prevent installation personnel from having access to the camera sensor device. This may be a problem, since electricians, telco personnel, and others need access to the system at installation and during maintenance. It is therefore advantageous to enclose the system's video camera in a concealing enclosure 310 as shown in FIG. 3. Enclosure 310 need not be present in the system during system installation, or when utility personnel are installing power or WAN connections. If desired authorized personnel may install the camera enclosure after the rest of the system is installed and operating, thus preventing the unauthorized utility installers from learning the purpose of the device or having access to a more fragile component.

FIG. 3 depicts additional features of the internal camera/pan-tilt enclosure. FIG. 3A depicts the overall camera/pan-tilt enclosure, with the top portions of the enclosure 311 cut away to expose the internal mechanism. A video camera 305 is mounted on a pan-tilt mechanism, consisting of a fixed baseplate 302, left/right-movable vertical support 303, and tillable camera mounting plate 304. This entire assemblage of camera, pan-tilt mount, and enclosure comprises a single replaceable module. At the base of the assembly, a pair of flanges 301 extends outwards from the assembly. These flanges allow the assembly to be mounted securely onto the previously described baseplate, which contains a pair of channels or slots to capture flanges 301. Removal and installation is thus greatly simplified. All connections to the camera and pan/tilt mechanism are routed through a single electrical connector (not shown) to simplify maintenance.

In FIG. 3B, the module is depicted with the exterior surface intact. It will be seen that a viewing aperture 309 provides the internal camera 305 with visual access to the exterior of the camera/pan-tilt enclosure. Aperture 309 matches a similar enclosure in the outer enclosure sidewalls (refer to FIG. 2). Note that the outer enclosure may be fashioned with apertures on both sides of the enclosure. This allows the camera/pan-tilt enclosure to be removed and re-installed on the opposite side of the mounting plate, allowing the camera to peer out the opposite side of the enclosure. Indeed, the outer enclosure may be fashioned with six such aperture windows, allowing the camera/pan-tilt enclosure to be positioned in any of six positions. Flanges 307 may additionally be placed on the front and back of the enclosure to permit this.

The use of internal camera enclosure 310 provides additional advantages. First, ambient outdoor light tends to enter the overall enclosure (200 in FIG. 2) via the unused viewing pane 202. This light, illuminating enclosure 200's internal components, tends to desensitize the video camera. Features of the equipment itself, when illuminated by the incoming light, may also become visible in reflections from the surfaces of the camera window. This problem is particularly acute when stray light reaches the inner surface of whichever pane 202 is currently being used. This light can easily produce glare and reflections in the camera's video. This problem of stray light leakage into enclosure 200 may be reduced, but not eliminated, through the use of an optically opaque material covering the unused pane 202. Such light leakage is effectively eliminated by enclosing the camera in camera enclosure 201.

The camera/pan-tilt enclosure is further protected against discovery and tampering by unauthorized personnel through the use of a lock mechanism. This lock mechanism may be mounted on the camera/pan-tilt mechanism, or on an adjacent mechanical structure. It engages or disengages a locking tab that prevents the camera/pan-tilt enclosure from moving, effectively locking it in place.

In the preferred embodiment, the lock mechanism is centrally located between two positions. This allows for one lock mechanism to retain the camera module in one of two designated mounting areas.

Modular Approach

These products, disguised as simple utility boxes, are generally mounted high above ground on utility poles or walls. As such, they are not easily accessible for maintenance. It is therefore desirable to ease and simplify system maintenance as much as possible.

To simplify maintenance, the invention uses the foregoing concept of removable modules throughout the entire covert surveillance system. This greatly simplifies problems associated with field maintenance and spares inventory. In FIG. 2, Network Router 203 is mounted on a removable tray, which is secured into the system's mounting frame via a pair of thumbscrews. The Network Router module 203 may thus be easily removed and replaced. Likewise, the Network Wireless Bridges or Access Points 204 are mounted on a similar removable tray, and may be easily disconnected and removed for system maintenance.

The Power Panel module contains a variety of power conditioning and switching circuitry described below. In keeping with the modular approach, this module is fully connectorized, and is attached to the system's mounting frame via a pair of thumbscrews. It may thus be easily disconnected, removed, and replaced for maintenance.

The Power Panel module contains a simple wireless remote-control device, to allow personnel to power the system ON or OFF without having direct physical access to the system. The associated wireless remote control antenna is likewise mounted on an easily removable plate, to facilitate removal and replacement. To further simplify maintenance, all removable modules are labeled with some simple numerical or alphabetic designation. So, for example, the camera/pan-tilt module is labeled ‘A’, the encoder module is labeled 13′, the router shelf is labeled ‘C’, the Power Panel module is labeled D, and so on. This simplifies maintenance, since untrained field personnel need only locate and replace an easily identified module.

Line Power Surge Circuitry

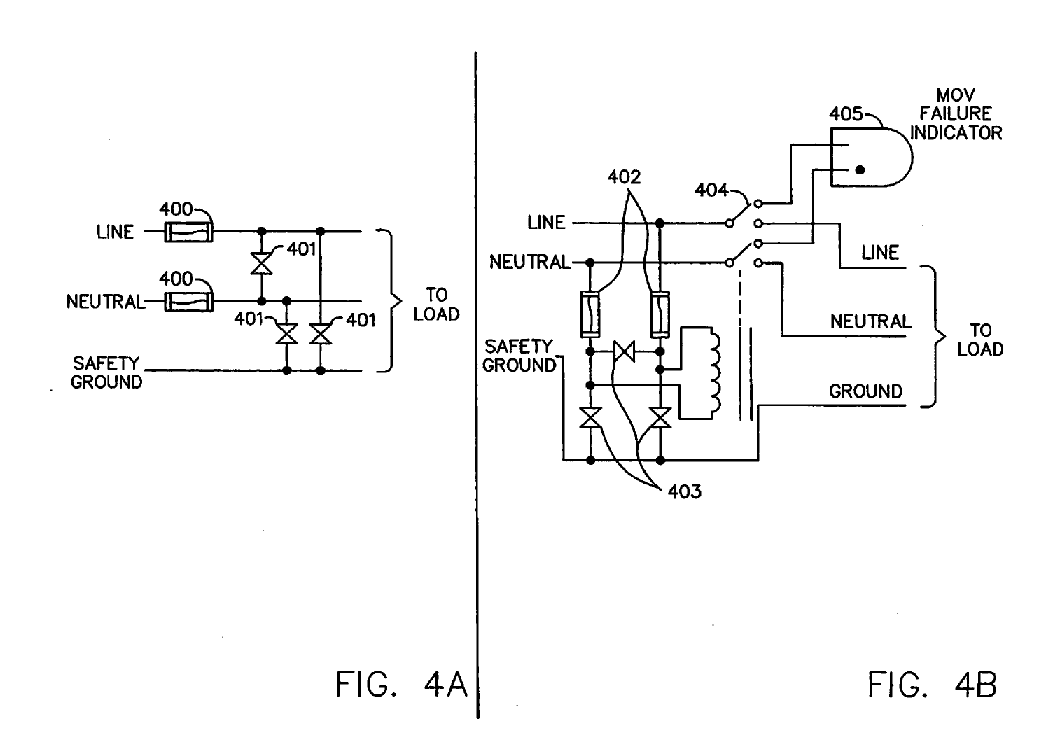

The device is located in an outdoor environment, and is not normally supplied with filtered, conditioned AC power. As such, the incoming AC power often contains potentially destructive electrical transients due to nearby lightning. Some form of lightning protection is therefore mandatory. In common practice, a set of common Metal Oxide Varistor (MOV) devices is used to clamp the AC powerline voltage to a safe level. This is depicted in FIG. 4A. A set of three MOV devices 401 are used: one from LINE to NEUTRAL, and one each from LINE to GROUND and one from NEUTRAL to GROUND. This provides protection against both common-mode transients and against differential transients.

While effective, MOV voltage clamps are well known to have a limited lifetime, often limited to some thousands or perhaps hundreds of lightning events. Moreover, these devices often fail in a shorted state. This poses a serious fire hazard, since one of the MOV devices is installed across the incoming AC power lines.

Prior art practice is to place a pair of thermal fuses 400 in direct physical contact with the MOV devices. This is, for example, the implementation used in the Leviton 3800 series of OEM surge protectors. These thermal fuses 400 are wired in series with the incoming AC line. As a result, a shorted MOV device will become warm and cause the protective thermal fuse to open, protecting the system from fire. Unfortunately, the series thermal fuse also removes power from the system as a whole.

In the invention, ease of maintenance is given high priority. Accordingly, it is desirable to have an illuminated indicator to tell service personnel of the MOV failure. This is accomplished by relocating the thermal fuses rather than being in series with the load, the thermal fuses are located in series with the MOV array. This is shown in FIG. 4B. A load relay 404 is normally ON, energized by line voltage present on the MOV terminals. Power is thus provided to the road circuitry via the relay contacts. Upon failure of an MOV 403, one or more thermal fuses 402 open due to the MOV's excess temperature. This de-energizes the coil of relay 404, and removes power from the load. The same relay 404 switches power to a panel-mounted illuminated indicator 405, which alerts service personnel that an MOV failure has occurred. An audible indicator may also be used to alert service personnel.

Such a visual or audible alert is useful to maintenance personnel who need to service the device. However, such an alert does nothing to alert monitoring personnel, at remote locations, of the nature of the system failure. For example, if a system fails due to an MOV failure during a thunderstorm, the protection circuitry effectively switches the unit OFF. The system is thus unable to alert remote personnel of the cause of the failure. There are several solutions to this problem:
A short-duration backup battery system may be used, to operate the system on backup power long enough to generate and transmit such an alarm message via the usual network interface. This may be safely accomplished, since the system is disconnected from the AC mains during this time.
An alternative communications pathway may be utilized to transmit such an alarm message. For example, cellular phones, or small handheld Personal Digital Assistants are both inherently battery powered. These may be used to transmit the ‘Protection Failure’ message to a server; since they are inherently battery powered and can therefore operate even after the system's surge protection circuitry has removed AC power from the system.

Advantages over the prior-art implementation include:
Failure of any MOV/thermal fuse will disconnect both sides of the line.
Failure of any MOV/thermal fuse will signal a failure indicator light/aural device.
Thermal Fuses are only carrying MOV loading, not equipment load.

Remote Control Reset

As described, the device contains a number of LAN/WAN routers, switches, bridges, and access points. Such devices are highly complex, and sometimes may fail or ‘hang’ due to software or firmware errors. It is occasionally necessary to turn the system power OFF then ON, to recover from such a system error.

Since the system is often mounted on a utility pole, or high on a wall, it is often not convenient to cycle power to recover from such a system error. Accordingly, the power panel module contains a simple wireless remote-control receiver, capable of receiving a signal from a commonplace ‘keyfob’ style remote control transmitter. Such transmitters are often used for opening car doors or garage doors. In the present invention, a two-button keyfob transmitter is used. One button turns the system power OFF, and the other button turns the system power ON. Using this approach, personnel may recover from a fatal system error by cycling the system's power, without direct physical access to the system.

This means of remote control of power may, of course, be implemented using other types of wireless devices. Such approaches may provide additional functionality beyond the simple power on/off function described earlier. For example, a simple cellular telephone, equipped with a battery, may be used as the wireless communication device. This cellular phone, equipped with a battery, may be continuously powered by system power during normal operation. During a system fault condition, the cellular phone may continue to operate from battery power, even though the rest of the system has shut down due to MOV failure or a temperature fault. Upon such a system shut-down, the cellular phone can report the reason for the shutdown. Other types of wireless devices can be used to similar purpose, such as battery-powered Personal Digital Assistants (PDA's) which contain wireless network interfaces, and the like.

Flexible Network Configuration

As described previously, the system contains a number of networking components. FIG. 2 depicts a network router 203 with wired WAN interfaces 206, and a pair of wireless network bridges and/or access points 204. A variety of wireless antennas (not shown) may be used. High-gain antennas may be used to make long-haul connections to distant networks. Smaller, low-gain antennas may be installed inside enclosure 200 to make local wireless connections.

The availability of such a variety networking equipment allows great operational flexibility. The following figures depict several such scenarios:

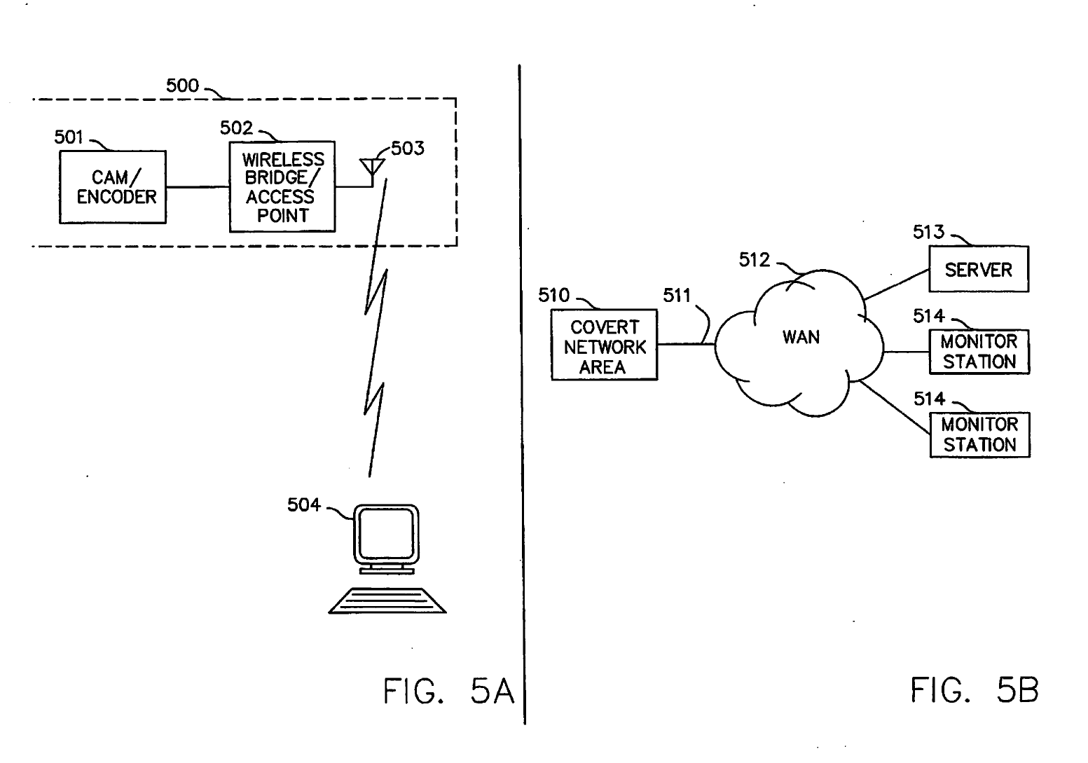

In FIG. 5A, covert network camera 500 contains a camera/digital encoder 501, a wireless network bridge or access point 502, and an antenna 503. A nearby laptop computer 504, equipped with a wireless interface, is capable of receiving, displaying, and/or storing video imagery produced by covert camera 500. This illustrates a basic ‘wireless’ usage of the system.

FIG. 5B depicts another system configuration. In this configuration, covert networked camera 510 uses a hardwired connection to a wide-area-network (WAN) 512. This hard-wired connection may take the form of a T-1 connection, ISDN, DSL, and the like. WAN 512 distributes the camera's video to a variety of clients, such as a networked server 513 which may store the camera imagery, or monitor stations 4514 which may view the camera video.

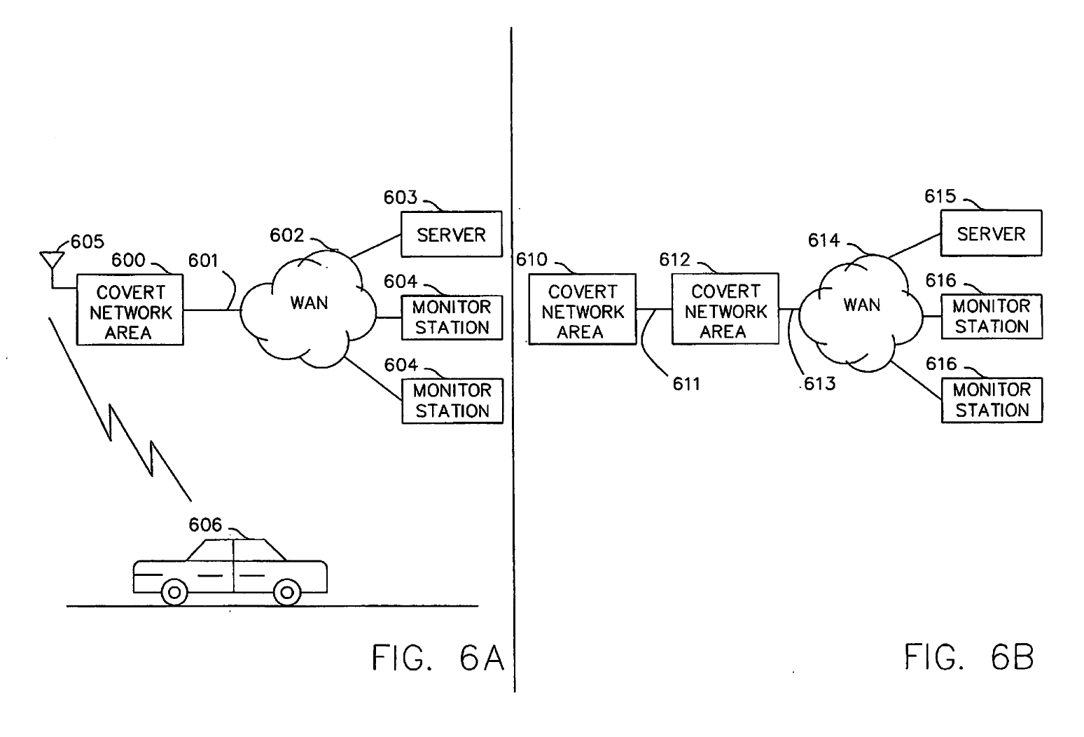

In FIG. 6A, covert networked camera 600 again uses a hardwired connection 601 via WAN 602 to a server 603 and one or more monitor stations 604. Additionally, camera 600 is equipped with a wireless access point and antenna 605, which support a local wireless connection to vehicle 606. The local vehicle 606 is equipped with a laptop computer or equivalent networked computer, which allows occupants to view and/or record video imagery produced by camera 600. In effect, camera 600 supports a local ‘hot spot’, where a vehicle may park & capture camera video.

FIG. 6B depicts how two or more covert network cameras, each equipped with wireless networking equipment, may be interconnected. Covert network camera 610 captures video imagery, and transmits said imagery via wireless connection 611 to a second covert network camera 612. Camera 612 may also be equipped with a camera and encoder; thus capturing its own video imagery. Camera 612 passes both of the aforementioned video streams via wired connection 613 and WAN 614 to a server 615 and monitor stations 616. In effect, camera 612 serves as both a covert network camera and a wireless relay point, to receive and forward video imagery captured by camera 610.

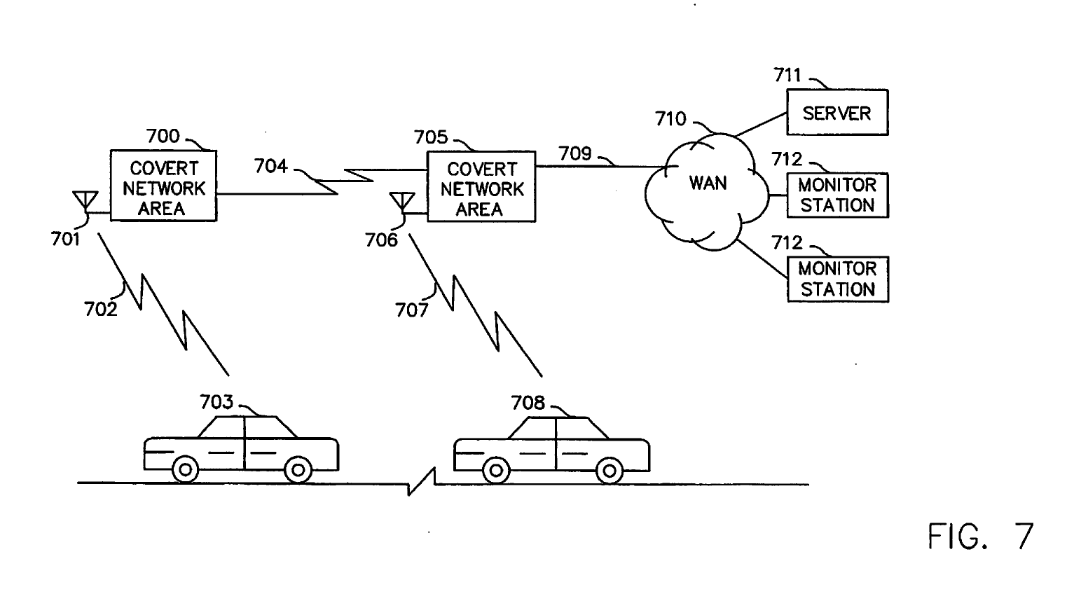

In FIG. 7, the cascaded network cameras are each supplemented with wireless access points and associated antennas, thus providing each covert network camera with a local ‘hot spot’. Camera 700 contains a camera which captures local video imagery, and conveys said video to a second covert network camera 705 via wireless link 704. As before, camera 705 forwards both it's own video imagery, and that captured by camera 700, via hard wired connection 709 and WAN 710 to a server 711 and monitor stations 712. In addition, camera 700 is equipped with a wireless access point 701, which conveys its own video imagery via local wireless link 702 to nearby vehicle 703. Likewise, camera 705 is equipped with a wireless access point 706, and conveys its own video imagery via link 707 to nearby vehicle 708. Note that this configuration, drawing upon the advantages of digital networking, allows each of the two vehicles to retrieve video captured by the other camera if desired. In fact, this configuration may be extended to more than two such cameras, allowing any vehicle to access video imagery captured by any camera on the network.

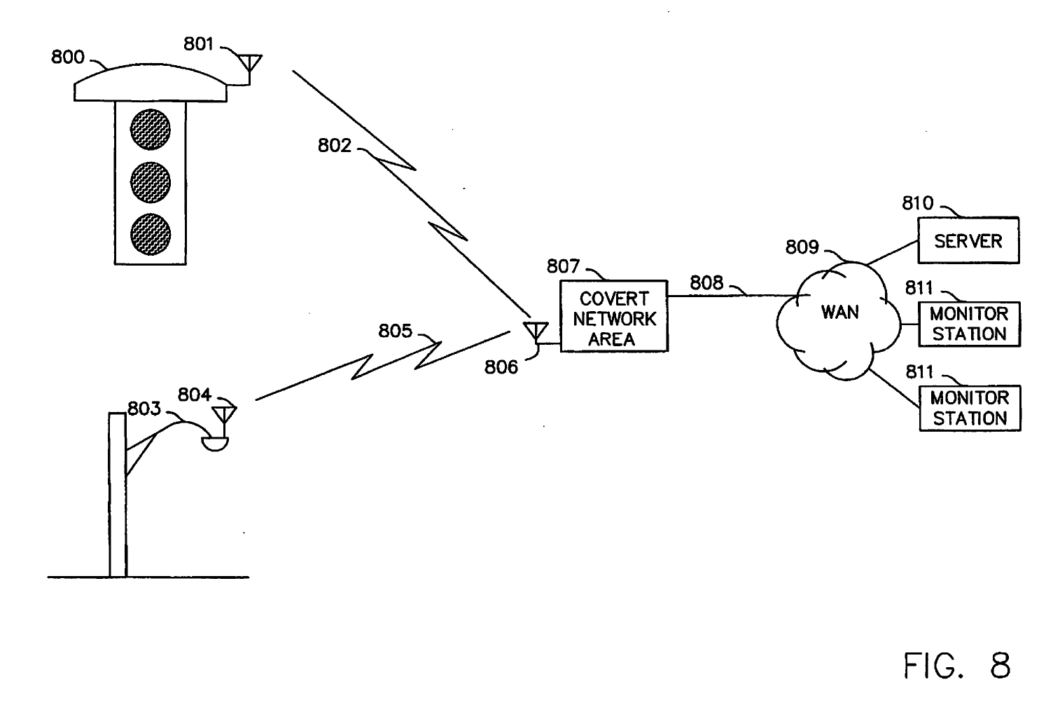

In the previous configurations, one of the covert network cameras acted as a wireless relay point to the WAN for one or more remote cameras. The camera acting as the relay point may additionally be equipped with an internal camera, allowing it to capture video imagery in addition to relaying imagery from other cameras to the WAN. FIG. 8 illustrates that the remote cameras need not necessarily be in the same type of covert housing as before. For example, a traffic light 800 may be equipped with a camera, encoder, and wireless communications device, and may transmit captured video imagery via access point & antenna 801 via link 802 to the network camera 807 which serves as the relay. Likewise, a camera and encoder may be embedded in a streetlight fixture 803, and may forward its captured video via access point & antenna 804 via link 805 to the network relay point 807.

Encryption of Networked Video

The security of the networked video signal is important in surveillance applications. It is undesirable to allow unauthorized personnel to intercept and view the video imagery. Prior art point-to-point analog systems achieve some degree of security since the video is received at only one receiving site, and not networked therefrom. On the other hand, the camera's video signal is carried by an analog microwave link, vulnerable to interception. Moreover, the analog video signal itself is difficult to encrypt effectively. A variety of analog video security schemes have been in use for some time, but none of these schemes offer particularly effective security. Moreover, some of these schemes result in unavoidable degradation of the video signal.

In the invention, the video signal takes the form of a compressed digital bitstream. Digital bitstreams are easily and effectively encrypted, without any degradation to the data being transported. A variety of such encryption schemes exist, of varying effectiveness, and none of them result in loss or degradation of data. Examples include DES, RSA, and AES to name a few common algorithms. Such encryption may in fact be accomplished inside the network router itself. Alternatively, the system of FIG. 2 may be supplemented with an additional device to accomplish more sophisticated encryption, if desired. Such an upgrade is relatively simple, possibly taking the form of a simple hardware module with two commonplace Ethernet I/O ports.

Geolocation Applications

FIG. 2 depicts a covert network camera equipped with a GPS receiver. A number of alternative Geolocation services are available with varying degrees of accuracy and/or coverage area. GPS is preferred, because it offers the best accuracy and had global coverage.

The addition of such a Geolocation device allows the addition of a number of new and useful features to the system. In FIG. 8, assume that covert cameras 800, 803, and 807 are all equipped with geolocation devices as discussed. With the addition of this function:
Geo-location on sensor can automatically provide lat/long info stored with images or video streams.
Geo-location on sensor can automatically provide lat/long display with each image/video window selected to be displayed from archive.
Geo-location on sensor can automatically provide real-time lat/long display with each image/video window selected.
Clicking on a hot-spot of an image or video stream can pull up a map displaying the exact location of that image or video stream. This applies to real-time displays or archived displays.
The link above can vector to commercial Web Sources, such as MapQuest.
The link above can vector to local map databases.
With a cluster of geo-location enabled sensor devices, an alarm event on one sensor can alert mobile units that are in the same geo-proximity.
With a cluster of geo-location enabled sensor devices, an alarm event on one sensor can activate displays of one or more closely located additional sensor, such as may be determined by automatic analysis of other geo-location data.
An application program can monitor the geo-location of a wireless phone providing the “911” geo-location data. (A wireless phone shall include cell phones EP phones or other wireless protocol communications device not necessarily “cellular” Wireless two-way pagers, PDA's and laptop computers may also be included.) This data is available when phone is turned on, and does not require a call to be in progress. The application program is also aware of the location of the geo-location identified sensors. These locations can be manually entered, or automatically when the sensor is equipped with geo-location itself. The application program is comparing the location of the wireless phone to available sensors. When the wireless phone is within the determined ‘range’ of the sensor, actions may be taken. Actions may include:
   Activation of visual and/or aural alarms at a monitor station.
   Event notification such as via. Cellular telephone, alphanumeric pager, and the like. The notification can include the geographic location in lat/long format, or by translation to common street name and street address via map look-up process in a well-known manner.
   Automatic dispatch of mobile or pedestrian responders.

Geolocation data may be sent to the responders and automatically inserted into on-board or hand carried GPS location devices associated the responder. This would automatically direct the responder to the exact location of the event in a very efficient manner.

An extension of the above concept is that a sensor that is equipped with a pan, tilt, or zoom capability can reposition the camera sensor system to the location of the monitored wireless device. This is accomplished by calculation of the dimensional vector between the wireless device being monitored and the sensor location. The sensor can then be positioned to “see” the monitored device. In the preferred embodiment the tilt and pan would position the camera on target, then the zoom would be adjusted to compensate for the range between the sensor and the monitored device/person. The zoom settings can be derived from look-up tables, or by calculations in a well-known manner.

In another embodiment of the invention, surveillance of a telephone booth by a camera is possible. There is GPS on the camera and GPS on the telephone booth. The positions are used to link the two. Further features include:

1) GPS or other geo-location technique associated with the sensor—camera reporting its location.
2) GPS causes the sensor to identify where it is on the map.
3) The telephone can be a wireless telephone including cellular.
4) The wireless telephone can have its location identified either by GPS or by other means such as the RF phasing, triangulation, time delay measurement and other techniques identified for geolocating 911 calls.
5) The system will select a nearby camera when it is determined that a wireless telephone is in proximity to a sensor.
6) The above can be determined by comparing the sensor location with the telephone location, and activating the camera to a screen, or generating an alarm for an operator, when the software determines that the two are in close enough proximity.
7) The camera/sensor, if equipped with tilt, pan, zoom, can track the wireless telephone by calculating the coordinates from the sensor/camera to the wireless telephone, then instructing the tilt, pan and/or zoom to go to settings that will ideally show the wireless camera and associated user.

Further features and specifications include:
LAN interfaces: 802.1x, 802.3
Optional WAN interfaces: ADSL, SHDSL, T-1 DSU, ISDN
Compression techniques:
   MPEG—30 fps, 352×240 and/or 176×112
   MJPEG—30 fps, 176×112
   JPEG—2 fps, 704×480
Software Requirements: SiteWatch™ 2.6 or later
Major components labeled for easy field service.
Camera module and patch antenna mounted in reversible locations.
Functionality/Power:
   Day/night
   Color
   18× optical zoom
   Pole-mount, covert enclosure.
      Connectivity with:
      HQ via 802.11b or wireline (ADSL, SHDSL, ISDN or T-1)
      Local investigator via 802.11b (multicast)—internal antenna with option for external antenna.
      Repeater station via 802.11b—external antenna
      Support auxiliary cameras via 802.11b—constrained by RF interference and available bandwidth.
   Support system PoR from the ground to reboot camera and LAN/WAN devices.
   VPN, encryption, etc. as supported by the Cisco 1721 router.
   Detect opening box and send event alarm
   Lightning protection—self resetting unless direct hit.
   120 VAC, 550 watts max
Shipping/Transportation Carrying Case: Pelican-style with wheels.
Size: 25″h×17.6″w×10″d
   Color: grey
   Environmental: −40 C to

Covert Outdoor Camera System

The camera system of the present invention is preferably housed in a nondescript fiberglass utility box, and is intended to be mounted on a pole. Internally, a camera module is mounted on a small Pan/Tilt mechanism. An e-Watch encoder and a variety of wireless networking equipment connects the device to the customer's network

The basic system consists of:
A plastic NEMA-4× rated enclosure
A TEC heater/cooler module, mounted on the bottom surface
An e-Watch ENC-300 module
A small Ethernet switch mounted on a bracket next to the encoder
A lockable aluminum housing, containing a small pan/tilt mechanism and a Sony camera block
An aluminum frame for mounting various equipment modules
A Modular Router, mounted on a removable module

The interior is divided into upper and lower compartments. The upper compartment contains the camera/pan-tilt housing, the ENC-300 module, the Ethernet switch, and an optional wireless antenna. The lower compartment contains removable shelves for the router and an optional removable module which contains a wireless Bridge & Access Point.

The enclosure is perforated with several waterproof connectors or bushings, as follows:
An AC power cable enters the enclosure through a waterproof bushing
Two coaxial Type-N receptacles/lightning arrestors (for the Wireless options) are mounted through the enclosure's surface.
A waterproof bushing for external network cables perforates the enclosure's surface, and
A ground stud for grounding the unit.

Estimated heat load is 75 watts or less. The Thermoelectric Cooler (TEC) module, located on the bottom surface of the enclosure, is capable of reducing the internal air temperature by approximately 20° C. with a 75 watt thermal load. The TEC module provides a stirring fan in the interior of the enclosure. The interior structural design effectively baffles and directs the cooling airflow throughout the interior components. At low temperatures, the TEC is used to heat the internal air. TEC operation is controlled by an internal thermostat, which controls the heating & cooling functions of the TEC.

Configurations/Model Codes

The product array consists of several ‘base’ model codes, and a series of optional model codes.

Base Model Codes

There are three base model codes. Each of these contains:
An enclosure
A TEC module on the bottom surface
An internal equipment mounting frame
A modular router, mounted on a removable module
A small Ethernet switch
An AC power distribution assembly, mounted in front of the TEC
Surge suppression for the AC power and various WAN connections
Lightning arrestors for the (optional) external antennas.
No identifying product labels visible on the enclosure's exterior.

NEMA-100-X—Base Unit W/O Camera

This base model code is intended for use as a wireless relay. It contains only the items listed above in section 2.1.2.2. It does not contain the camera/pan-tilt housing or an encoder.

NEMA-100-C—Base Unit with Camera

Another base model code is a fully-functional camera system. In addition to the above, it contains the camera/pan-tilt housing, an e-Watch ENC310 encoder, and associated wiring harness.

WRL-100—Wireless Repeater

A third base product model code defines a commercial version of the ‘wireless relay’ product. This version is used to house the router and optional JP networking gear in the NEMA-4×, thermally-controlled enclosure. This version of the product is not intended to be covert, and has the product label on the outer surface of the enclosure. This version does not have side windows, since it contains no camera.

Product Options

CPT-100 Camera Upgrade Option

One upgrade option effectively upgrades a NEMA-100-X into a NEMA-100-C. This option consists of the camera/pan-tilt enclosure, an e-Watch ENC-310, and associated cables. These modules slide into slots in the mounting plate. The slots are horizontally symmetric, allowing the camera/pan-tilt enclosure to be mounted on either side of the mounting plate.

Another Model Code option provides an internal ‘patch’ antenna for the internal wireless Bridge or Access Point. This antenna mounts on an adjustable gimbal, which bolts into the mounting plate. If an encoder module is present, the antenna gimbal assembly bolts to the encoder's top pem nut. The antenna uses linear polarization, and the gimbal mount allows approximately 40° tilt. This product option is customer-installable.

WAN Interface Module Options

The product offers a number of WAN interface options. Some of these options install in expansion slots in the modular router. Others take the form of removable modules, which install in the equipment frame.

Optional WIC Modules

Some WAN options take the form of interface modules, which install into the WIC (WAN Interface Card) slots in, for example, a Cisco 1721 Modular Access Router. The Cisco 1721 has two such option slots. These option Model Codes include a surge suppressor module, which installs into a slot in the side of the power panel, described later. These option Model Codes also include the necessary cable, which installs between the WIC module and the surge suppressor module.

Although an exemplary embodiment of the system and method of the present invention has been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. For example, the capabilities of the cameras or camera systems can be performed by one or more of the modules or components described herein or in a distributed architecture. For example, all or part of a camera system, or the functionality associated with the system may be included within or co-located with the operator console or the server. Further, the functionality described herein may be performed at various times and in relation to various events, internal or external to the modules or components. Also, the information sent between various modules can be sent between the modules via at least one of a data network, the Internet, a voice network, an Internet Protocol network, a wireless source, a wired source and/or via plurality of protocols. Still further, more components than depicted or described can be utilized by the present invention.

What is claimed is:

1. A digital networked security surveillance system for use in a covert environment, comprising:
a camera enclosure including a video camera and a pan-tilt camera mount mechanism;
a mounting plate coupled to the enclosure;
wherein a lens of the camera is adjacent to at least one of transparent viewing panes;
wherein the viewing pane may be disguised with a semi-transparent decal to prevent individuals from seeing the camera, yet can allow the camera to capture light originating outside of the enclosure; and
an encoder coupled to the mounting plate, wherein the encoder is adapted to digitize and compress video.

2. The system of claim 1, wherein the camera may be fixed in position or may be movable.

3. The system of claim 1 comprising other of the viewing panes located on a front surface and a rear surface of the enclosure, to allow the pan-tilt mechanism to be positioned to view through the other viewing panes.

4. The system of claim 1, wherein more than one camera may be positioned, with our without a pan/tilt mechanism, such that it can view out of more than one viewing pane.

5. The system of claim 1, wherein the camera may be positioned such that it can view out of two or more viewing panes.

6. The system of claim 1 comprising an omni-directional sensor coupled to the mounting plate, wherein the omni-directional sensor can view out of two or more viewing panes.

7. The system of claim 1 comprising a geolocation device coupled to the mounting plate, wherein the geolocation device includes at least one of:
a separate receiver module and antenna module; and
an integrated receiver and antenna in one enclosure.

8. The system of claim 7, wherein the geolocation device is mounted near a top inner surface of the enclosure, wherein such a mounting provides the receiver with an unobstructed sky view.

9. The system of claim 7, wherein the geolocation device is mounted on top of or otherwise outside of the enclosure, wherein such a mounting provides the receiver with an unobstructed sky view.

10. The system of claim 8, wherein the geolocation device can be used to collect data to be stamped on images and video that is transmitted or recorded locally.

11. The system of claim 8, wherein the geolocation device is at least one of:
a GPS device;
a cellular telephone; and
devices adapted to perform triangulation, phase analysis, or time domain techniques.

12. The system of claim 1 comprising a heating/cooling device in the enclosure to guarantee that contents within the enclosure stay within their specified temperature range.

13. The system of claim 1 comprising a door switch to alert monitoring personnel when the system's door has been opened.

14. The system of claim 1 comprising a concealing enclosure to enclose the system's video camera.

15. The system of claim 14, wherein the enclosure need not be present in the system during system installation.

16. The system of claim 1, wherein the pan-tilt mechanism is used to mount a video camera.

17. The system of claim 16, wherein the pan-tilt mechanism includes a fixed baseplate, a left/right-movable vertical support, and a tillable camera mounting plate.

18. The system of claim 17, wherein the fixed baseplate, the left/right-movable vertical support, and the tillable camera mounting plate comprise a single replaceable module.

19. The system of claim 1 comprising pair of flanges extending outwards from a base of the enclosure.

20. The system of claim 19, wherein the flanges allow the enclosure to be mounted securely onto the baseplate.
